(19) United States
(12) Patent Application Publication
(10) Pub. No.: US 2013/0162234 A1
(43) Pub. Date: Jun. 27, 2013

(54) BUCK REGULATION OF A BOOST REGULATOR

(71) Applicant: Richtek Technology Corporation, Chupei City (TW)

(72) Inventors: Tzu-Huan CHIU, Jhubei City (TW); Jien-Sheng CHEN, Toufen Township (TW); Chen-Cin LI, Tainan City (TW)

(73) Assignee: RICHTEK TECHNOLOGY CORPORATION, Chupei City (TW)

(21) Appl. No.: 13/728,623

(22) Filed: Dec. 27, 2012

(30) Foreign Application Priority Data
Dec. 27, 2011 (TW) 100148940

(51) Int. Cl. G05F 1/62

(52) U.S. Cl. 323/282

(57) ABSTRACT

Buck regulation methods are provided for a boost regulator to convert an input voltage into an output voltage lower than the input voltage. The buck regulation methods can reduce the variation of the inductor current of the boost regulator, and thereby decrease power consumption and increase the efficiency of the boost regulator under buck regulation.

### FIELD OF THE INVENTION

The present invention is related generally to a boost regulator and, more particularly, to buck regulation of a boost regulator.

### BACKGROUND OF THE INVENTION

FIG. 1 is a circuit diagram of a direct-current-to-direct-current (DC-to-DC) boost regulator, which includes an inductor L connected between a voltage input terminal Vin and a switching node 12, an NMOS transistor N1 connected between the switching node 12 and a reference potential terminal Vss for use as a first switch, a PMOS transistor P1 connected between the switching node 12 and a voltage output terminal Vout for use as a second switch, a capacitor C connected between the voltage output terminal Vout and the reference potential terminal Vss, and a controller 10 to provide gate voltages Vn1 and Vp1 for controlling the NMOS transistor N1 and the PMOS transistor P1, respectively, to step up an input voltage Vin to generate an output voltage Vout. In addition, the PMOS transistor P1 has its substrate and source connected together to prevent its body diode from being turned on, which otherwise may allow a reverse current flowing from the voltage output terminal Vout to the voltage input terminal Vin. In most applications, the reference potential terminal Vss is a ground terminal, i.e. Vss=0V.

In the circuit of FIG. 1, if the input voltage Vin is higher than the desired level of the output voltage Vout over the threshold voltage of the PMOS transistor P1, then the capacitor C will be charged by the power supply Vin. Therefore, all regulators having this type of circuit configurations can only be used for boost regulation and are impossible to operate for buck regulation. This limitation makes such type of regulators unsuitable for use in devices powered by batteries. In the life time of a battery, the supply voltage of the battery is initially higher than the voltage demanded by the device powered by the battery, which thus requires a regulator for buck regulation; however, after the voltage of the battery becomes lower than the voltage demanded by the device due to power consumption of the battery, a regulator for boost regulation is needed. In such applications, only converters having relatively complex circuits, such as converters having combined buck regulator and boost regulator and single-ended primary inductor converters (SEPICs), can be used, which, however, increases the costs of the components.

For simpler circuits available for both buck regulation and boost regulation, as shown in FIG. 2, U.S. Pat. No. 7,084,611 taught to add a PMOS transistor P2 to the circuit shown in FIG. 1, in which the PMOS transistor P2 has its substrate and drain both connected to the substrate of the PMOS transistor P1 and its source connected to the source of the PMOS transistor P1, and is controlled by a gate voltage Vp2 provided by the controller 10. Operation of the circuit shown in FIG. 2 for buck regulation are shown in FIG. 3, in which the waveform 14 represents the voltage VLX at the switching node 12, the waveform 16 represents the input voltage Vin, the waveform 18 represents the output voltage Vout, the waveform 20 represents the gate voltage Vn1 of the NMOS transistor N1, the waveform 22 represents the gate voltage Vp1 of the PMOS transistor P1, and the waveform 24 represents the inductor current IL. Referring to FIGS. 2 and 3, when the input voltage Vin is higher than the desired level of the output voltage Vout, the controller 10 continuously applies a gate voltage Vp1 as shown by the waveform 22, which is higher than the difference between the input voltage Vin and the threshold voltage Vt of the PMOS transistor P1, to the PMOS transistor P1 to maintain the PMOS transistor P1 off, and switches the NMOS transistor N1 as shown by the waveform 20, to step down the input voltage Vin to generate the lower output voltage Vout as shown by the waveforms 16 and 18.

In further details, during the down mode, Vp1=Vp2=Vin. When the NMOS transistor N1 is on, for example, as shown from time t1 to time t2 in FIG. 3, VLX=Vss=0V as shown by the waveform 14, and the inductor current IL increases at a slope of (Vin−Vss)/L as shown by the waveform 24. When the NMOS transistor Ni is off, for example, as shown from time t2 to time t3 in FIG. 3, the voltage VLX increases so that Vp1−VLX=V1<Vt, and thus the PMOS transistor P1 is at a partially on state such that the inductor current IL flows to the voltage output terminal Vout through the PMOS transistor P1; as a result, the inductor L releases energy into the capacitor C and the inductor current IL decreases at a slope of (Vin−VLX)/L. However, when the inductor current IL flows through the NMOS transistor N1 and the PMOS transistor P1, due to the on resistances of the NMOS transistor N1 and the PMOS transistor P1, power consumption is generated and thereby the efficiency of the regulator degrades.

### SUMMARY OF THE INVENTION

An objective of the present invention is to provide a buck regulation method for a boost regulator.

Another objective of the present invention is to provide a boost regulator capable of operating for buck regulation.

A further objective of the present invention is to provide a buck regulation method for a boost regulator to reduce the variation of the inductor current of the boost regulator.

According to the present invention, a buck regulation method for a boost regulator includes maintaining a first switch connected between an inductor and a reference potential terminal off, and switching a PMOS transistor connected between the inductor and an output terminal of the boost regulator to convert an input voltage at an input terminal of the boost regulator into an output voltage at the output terminal, wherein the output voltage is lower than the input voltage.

According to the present invention, a buck regulation method for a boost regulator includes turning off a PMOS transistor connected between an inductor and an output terminal of the boost regulator and turning on a first switch connected between the inductor and a reference potential terminal for charging the inductor, then, turning off the first switch and turning on the PMOS transistor, and finally, turning off both the first switch and the PMOS transistor for discharging the inductor.

According to the present invention, a boost regulator includes an inductor connected between an input terminal of the boost regulator and a switching node, a first switch connected between the switching node and a reference potential terminal, a PMOS transistor connected between the switching node and an output terminal of the boost regulator for use as a second switch, and a controller connected to the first switch and the PMOS transistor, configured to control the first switch and the PMOS transistor. When the boost regulator is in a down mode, the controller maintains the first switch off and switches the PMOS transistor to convert an input voltage at the input terminal into an output voltage at the output terminal, wherein the output voltage is lower than the input voltage.

According to the present invention, a boost regulator includes an inductor connected between an input terminal of the boost regulator and a switching node, a first switch connected between the switching node and a reference potential terminal, a PMOS transistor connected between the switching node and an output terminal of the boost regulator for use as a second switch, and a controller connected to the first switch and the PMOS transistor, configured to control the first switch and the PMOS transistor. When the boost regulator is in a down mode, the controller executes the following steps in sequence: turning off the PMOS transistor and turning on the first switch for charging the inductor, turning off the first switch and turning on the PMOS transistor, and turning off both the first switch and the PMOS transistor for discharging the inductor.

The buck regulation method and the boost regulator according to the present invention can reduce the variation of the inductor current to thereby reduce the power consumption and improve the efficiency of the boost regulator.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a conventional DC-to-DC boost regulator;

FIG. 2 is a circuit diagram of a conventional DC-to-DC boost regulator available for buck regulation;

FIG. 3 is a waveform diagram of the circuit shown in FIG. 2 under buck regulation;

FIG. 4 is a flowchart of a method applied to the boost regulator shown in FIG. 2 for buck regulation according to the present invention;

FIG. 5 is a waveform diagram of the circuit shown in FIG. 2 when the method shown in FIG. 4 is applied; and

FIG. 6 is a flowchart of a method applied to the boost regulator shown in FIG. 1 for buck regulation according to the present invention.

### DETAILED DESCRIPTION OF THE INVENTION

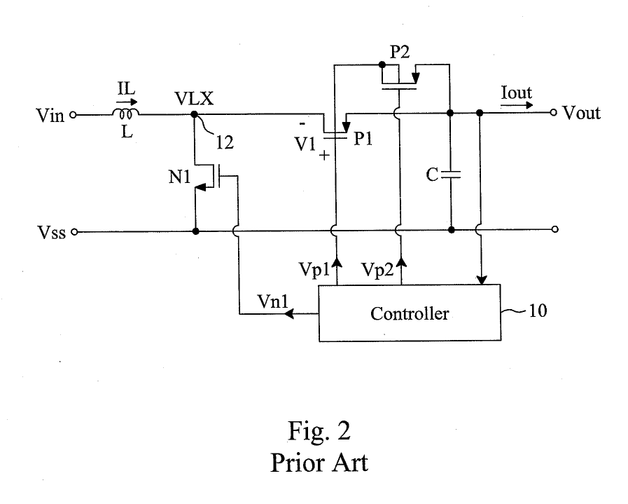

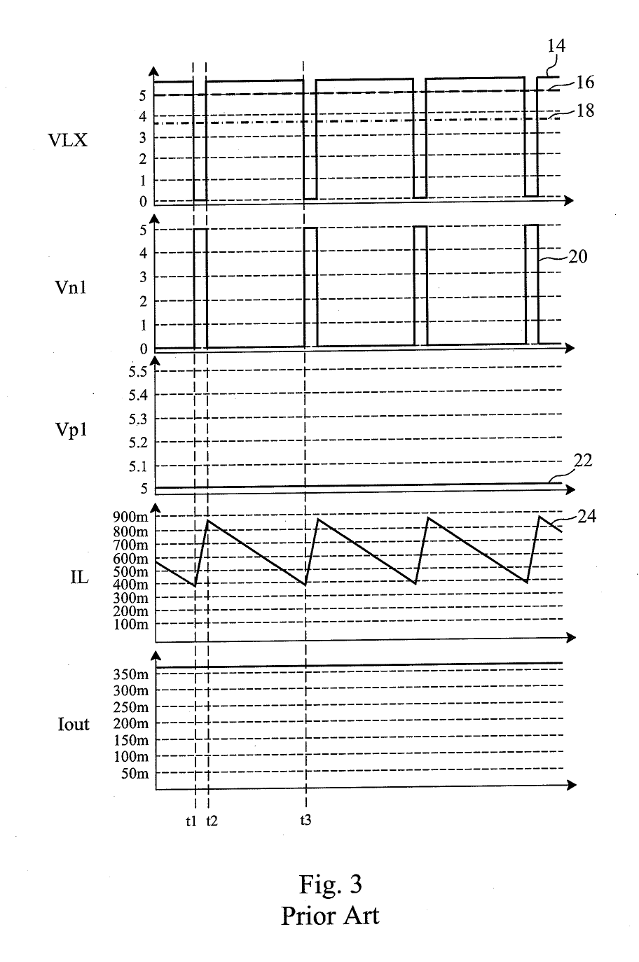

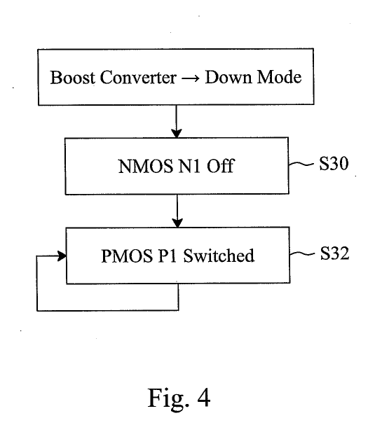

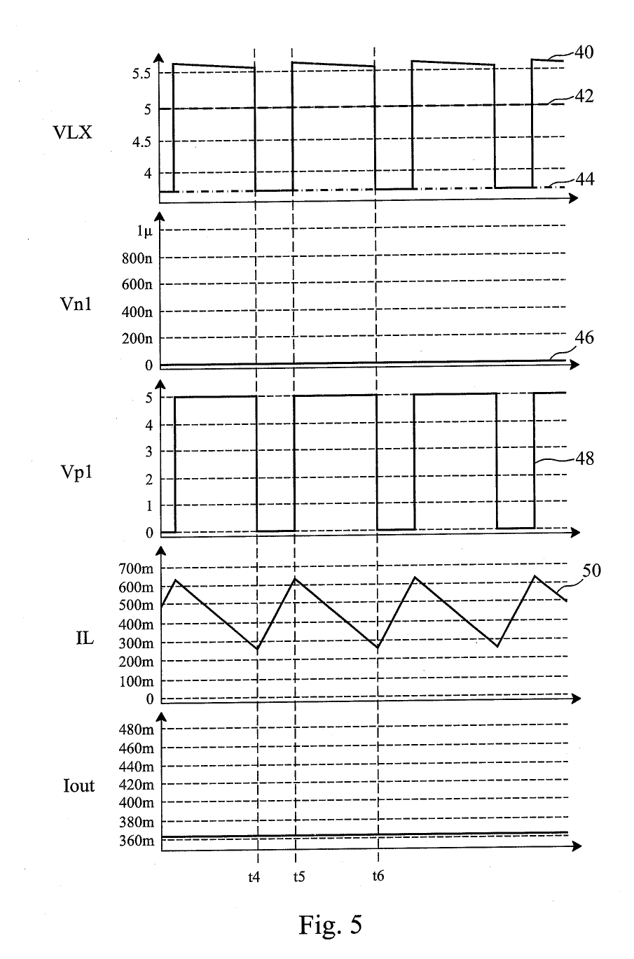

FIG. 4 is a flowchart of a method applied to the boost regulator shown in FIG. 2 for buck regulation according to the present invention, and FIG. 5 is a waveform diagram it is generated. In FIG. 5, the waveform 40 represents the voltage VLX at the switching node 12, the waveform 42 represents the input voltage Vin, the waveform 44 represents the output voltage Vout, the waveform 46 represents the gate voltage Vn1 of the NMOS transistor N1, the waveform 48 represents the gate voltage Vp1 of the PMOS transistor P1, and the waveform 50 represents the inductor current IL. The simulation conditions that generate the waveform diagram of FIG. 5 are the same, i.e., the same input voltage Vin, the same output voltage Vout and the same output current Iout, as those of FIG. 3, where the output current Iout is the one at the output terminal Vo of the boost regulator. Referring to FIGS. 2, 4 and 5, after the boost regulator is switched to the down mode, step S30 maintains the NMOS transistor N1 off as shown by the waveform 46 in FIG. 5, and step S32 switches the PMOS transistor P1 on and off to convert the input voltage Vin of 5 V into an output voltage Vout of about 3.6 V as shown by the waveforms 42 and 44 in FIG. 5. When the PMOS transistor P1 is on, for example, as shown by the waveform 48 from time t4 to time t5, the inductor L is charged, and the voltage VLX at the switching node 12 is equal to the output voltage Vout as shown by the waveform 40, so the inductor current IL increases at a slope of (Vin−Vout)/L as shown by the waveform 50. When the PMOS transistor P1 is off, for example, as shown by the waveform 48 from time t5 to time t6, the voltage VLX at the switching node 12 rapidly increases first, and until the difference V1 between the gate voltage Vp1 and the voltage VLX becomes greater than the threshold voltage Vt of the PMOS transistor P1, the PMOS transistor P1 comes into a partially on state, and thus the inductor current IL flows to the voltage output terminal Vout through the PMOS transistor P1, so the inductor L discharges and the inductor current IL decreases at a slope of (Vin−VLX)/L.

In the embodiment shown in FIG. 5, it is applied a gate voltage Vp1 equal to the input voltage Vin to the gate of the PMOS transistor P1 to turn off the PMOS transistor P1; however, in other embodiments, the gate voltage Vp1 for turning off the PMOS transistor P1 may be any one greater than Vin−|Vt|. Preferably, the gate voltage Vp1 ranges between Vin and Vin−|Vt|.

In the conventional buck regulation method shown in FIG. 3, the slope at which the inductor current IL increases is (Vin−Vss)/L; however, in the buck regulation method according to the present invention, the slope at which the inductor current IL increases is (Vin−Vout)/L. Because the output voltage Vout is higher than the reference potential Vss, the buck regulation method according to the present invention can make the inductor current IL increase slower to generate a smaller variation, thereby reducing the power consumption caused by the on resistance of the PMOS transistor P1. Therefore, the buck regulation method according to the present invention can increase the efficiency of the boost regulator under buck regulation. Referring to the simulation diagrams of FIGS. 3 and 5, under the same conditions, the waveform 24 of the inductor current IL shown in FIG. 2 has a variation of about (850−380)=470 mA, while the waveform 50 of the inductor current IL shown in FIG. 5 has a variation of about (620−260)=360 mA, so the buck regulation method according to the present invention can indeed reduce the power consumption and increase the efficiency.

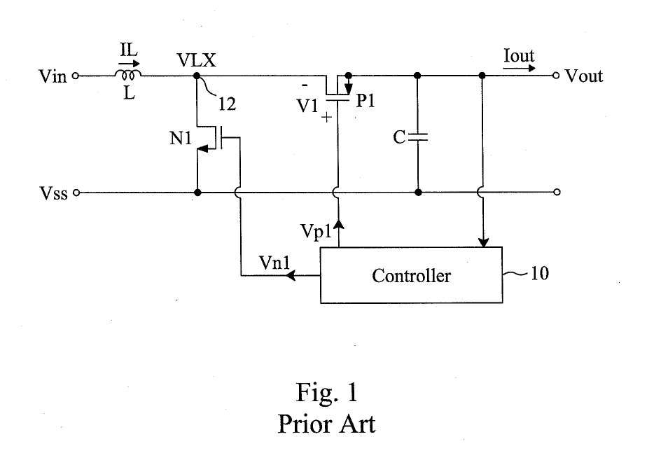

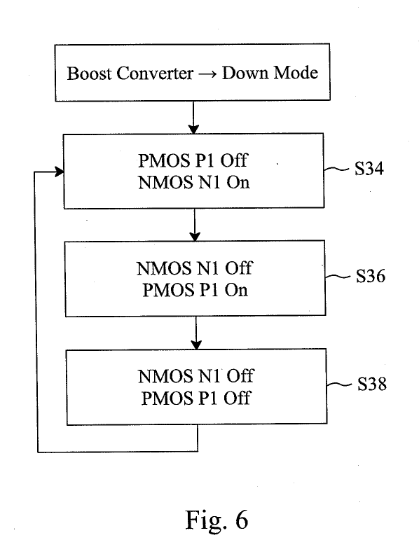

FIG. 6 is a flowchart of a method applied to the boost regulator shown in FIG. 1 for buck regulation according to the present invention. Referring to FIGS. 1 and 6, after the boost regulator is switched to the down mode, step S34 turns off the PMOS transistor P1 and turns on the NMOS transistor N1, so the inductor L is charged and the inductor current IL increases at a slope of (Vin−Vss)/L. Then, step S36 turns off the NMOS transistor N1 and turns on the PMOS transistor P1, so the slope at which the inductor current IL increases decreases to (Vin−Vout)/L. Finally, step S38 turns off both the NMOS transistor N1 and the PMOS transistor P1, so the voltage VLX at the switching node 12 rapidly increases first, and until the difference V1 between the gate voltage Vp1 and the voltage VLX becomes equal to the threshold voltage Vt of the PMOS transistor P1, the PMOS transistor P1 cones into a partially on state, thereby allowing the inductor current IL to flow to the voltage output terminal Vout through the PMOS transistor P1, so the inductor L discharges and the inductor current IL decreases at a slope of (Vin−VLX)/L.

In the conventional buck regulation method shown in FIG. 3, the increasing slope of the inductor current IL is always (Vin−Vss)/L, while in the embodiment shown in FIG. 6, the increasing slope of the inductor current IL is (Vin−Vss)/L at the beginning and then decreases to (Vin−Vout)/L. Therefore, the variation of the inductor current IL generated by the method shown in FIG. 6 is still smaller than the variation of the inductor current generated by the conventional method, thereby increasing the efficiency of the boost regulator.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A buck regulation method for a boost regulator including an inductor connected between an input terminal of the boost regulator and a switching node, a first switch connected between the switching node and a reference potential terminal, and a PMOS transistor connected between the switching node and an output terminal of the boost regulator for use as a second switch, the buck regulation method comprising:
A.) maintaining the first switch off; and
B.) switching the PMOS transistor on and off to convert an input voltage at the input terminal into an output voltage at the output terminal, wherein the output voltage is lower than the input voltage.

2. The buck regulation mode of claim 1, wherein the step B comprises applying a gate voltage to a gate of the PMOS transistor to turn off the PMOS transistor, the gate voltage being greater than a voltage that the input voltage minus an absolute value of a threshold voltage of the PMOS transistor.

3. A buck regulation method for a boost regulator including an inductor connected between an input terminal of the boost regulator and a switching node, a first switch connected between the switching node and a reference potential terminal, and a PMOS transistor connected between the switching node and an output terminal of the boost regulator for use as a second switch, the buck regulation method comprising:
A.) turning off the PMOS transistor and turning on the first switch for charging the inductor;
B.) turning off the first switch and turning on the PMOS transistor; and
C.) turning off both the first switch and the PMOS transistor for discharging the inductor.

4. The buck regulation method of claim 3, wherein the steps A and C comprise applying a gate voltage to a gate of the PMOS transistor, the gate voltage being greater than a voltage that the input voltage minus an absolute value of a threshold voltage of the PMOS transistor.

5. A boost regulator comprising:
an input terminal receiving an input voltage;
an output terminal providing an output voltage;
a reference potential terminal;
a switching node;
an inductor connected between the input terminal and the switching node;
a first switch connected between the switching node and the reference potential terminal;
a PMOS transistor connected between the switching node and the output terminal for use as a second switch; and
a controller connected to the first switch and the PMOS transistor, configured to control the first switch and the PMOS transistor;
wherein when the boost regulator is in a down mode, the controller maintains the first switch off and switches the PMOS transistor on and off to convert the input voltage into the output voltage smaller than the input voltage.

6. The boost regulator of claim 5, wherein when the controller is to turn off the PMOS transistor, it applies a gate voltage to a gate of the PMOS transistor, the gate voltage being greater than a voltage that the input voltage minus an absolute value of a threshold voltage of the PMOS transistor.

7. A boost regulator comprising:
an input terminal receiving an input voltage;
an output terminal providing an output voltage;
a reference potential terminal;
a switching node;
an inductor connected between the input terminal and the switching node;
a first switch connected between the switching node and the reference potential terminal;
a PMOS transistor connected between the switching node and the output terminal for use as a second switch; and
a controller connected to the first switch and the PMOS transistor, configured to control the first switch and the PMOS transistor;
wherein when the boost regulator is in a down mode, the controller executes following steps in sequence:
turning off the PMOS transistor and turning on the first switch for charging the inductor;
turning off the first switch and turning on the PMOS transistor; and
turning off both the first switch and the PMOS transistor for discharging the inductor.

8. The boost regulator of claim 7, wherein when the controller is to turn off the PMOS transistor, it applies a gate voltage to a gate of the PMOS transistor, the gate voltage being greater than a voltage that the input voltage minus an absolute value of a threshold voltage of the PMOS transistor.
